(19) United States
(12) Patent Application Publication
(10) Pub. No.: US 2013/0196365 A1
(43) Pub. Date: Aug. 1, 2013

(54) ANTIBIOFILM NANOPOROUS NANOSTRUCTURES AND METHOD TO PRODUCE SAME

(71) Applicants: Ganta S. Reddy, Hyderbad (IN); Jainagesh Sekhar, Cincinnati, OH (US)

(72) Inventors: Ganta S. Reddy, Hyderbad (IN); Jainagesh Sekhar, Cincinnati, OH (US)

(73) Assignee: MICROPYRETICS HEATERS INTERNATIONAL, INC., Cincinnati, OH (US)

(21) Appl. No.: 13/877,345

(22) PCT Filed: May 3, 2011
(86) PCT No.: PCT/US11/34879

§ 371 Date: Apr. 2, 2013

Related U.S. Application Data
(60) Provisional application No. 61/392,997, filed on Oct. 14, 2010.
(60) Provisional application No. 61/454,032, filed on Mar. 18, 2011.

(51) Int. Cl. C09D 5/16

(52) U.S. Cl. CPC C09D 5/1681
USPC 435/32; 428/315.7; 428/312.6; 428/312.8; 428/312.2; 428/221; 427/580; 118/620

(57) ABSTRACT

Durable nanoporous nanostructured materials that modify, eliminate and destroy biofilms that may develop due to the presence of bacteria, fungi and other microbes and method for making the same. Such nanoporous nanostructures may be deposited as coatings on a substrate and such coatings may include at least one nanopore and a plurality of nanoparticles which adhere to the substrate and/or other particles. The nanostructure can be produced using a single-sided electrode arrangement which is configured to produce an electrical arc or discharge at one end of an electrode and to emit the nanoparticles. The nanoparticles form a non-porous framework which delineates any nanopores and which can be deposited as one or more layers of nanothickness. Such nano structures may be resistant to removal from the substrate. Also described are testing methods and apparatus for the quick, accurate and simple evaluation of the efficacy of the antibiofilm properties of the nanoporous nano structure.

### CROSS-REFERENCE TO RELATED APPLICATIONS

This application claims the benefit of U.S. provisional patent application Ser. Nos. 61/392,997 filed on Oct. 14, 2010 and 61/454,032 filed on Mar. 18, 2011 both by the present inventors. This application incorporates the apparatus and method disclosed in U.S. Pat. No. 7,880,119 granted on Feb. 1, 2011 and PCT patent applications Serial Nos. PCT/US06/60621 published Jan. 1, 2009, PCT/US07/85564 published Jun. 3, 2010 and PCT/US09/45068 published Nov. 25, 2010, which are incorporated by reference.

### BACKGROUND

1. Field

This application relates to bioactive, antifungal, antibiofilm and antimicrobial, mostly inorganic, nanoporous nanostructures and their application to, and protection of, metallic and non-metallic surfaces from the formation of biofilms and other mixed mode growth as well as tests and test kits concerning the efficacy of such biofilm modification and microbe control and elimination.

2. Prior Art

Biofilms significantly impact the corrosion of surfaces by changing the rate of corrosion affecting the surfaces. Technically, biofilms are a conglomeration of bacteria, fungi, algae, protozoa, debris, or corrosion products embedded in a self-produced and secreted matrix of extracellular polymeric substances (EPS). The EPS can be composed of polysaccharides, proteins, nucleic acids, and lipids. Essentially, biofilm may form when bacteria adhere to surfaces in aqueous environments and begin to excrete EPS, a slimy, glue-like substance that can anchor them to all kinds of material—such as metals, plastics, soil particles, medical implant materials, and tissue. Biofilms can grow almost anywhere where there is moisture, nutrients and a surface. (See http://www.biofilm.montana.edu/biofilm-basics.html). Objects including faucets, faucet cartridges, sink strainers, toothbrushes, pacifiers, drains, pipes, toilets, bathtubs, tiles, tile grout and other bathroom and kitchen fixtures are examples of surfaces where biofilms often develop. Biofilms often are revealed by mineral deposits and staining.

Bacterial assisted corrosion in biofilms occurs on both metallic and non-metallic materials, with or without the presence of oxygen, given the proper conditions for bacterial colony-formation. For example, acidithiobacillus bacteria produce sulfuric acid and acidithiobacillus thiooxidans which frequently damage sewer pipes. Ferrobacillus ferrooxidans directly oxidize iron to iron oxides and iron hydroxides. Many common bacteria produce ammonia and various acids, both organic and mineral, all of which aid in various forms of corrosion. Microbial corrosion is caused by bacteria, biofilms and fungi which employ the electron donated by metallic corrosion (i.e., cause oxidation) for their energy use. Corrosion can be highly penetrative and the problems from bacterial corrosion may also impact the bulk material, not just the surface. The corrosion could be chemical, electro-chemical including pitting, uniform, stress related and other common types.

The problem appears to be becoming more acute. For example, the development of steels without chromium is an important and current research topic, but many such steels are very prone to microbial corrosion and leach out toxic substances during corrosion. Sulfate-reducing bacteria are common in oxygen depleted environments. These bacteria aid hydrogen sulfide production, thus causing sulfide stress corrosion cracking. In the presence of oxygen, some bacteria and biofilms directly oxidize iron to iron oxides and hydroxides; other bacteria oxidize sulfur and produce sulfuric acid causing biogenic sulfide corrosion. Concentration cells (bacterial colonies and biofilms) can form in the deposits of corrosion products, causing, and even enhancing galvanic corrosion. Some bacteria are able to utilize the hydrogen formed during the cathodic corrosion processes, thus promoting cathodic activity. Bacterial corrosion may also cause pitting corrosion in many applications, including pipelines used in the oil and gas industry. Anaerobic corrosion is often evidenced by layers of metal sulfides and also by a hydrogen sulfide smell. Bacterial corrosion, through selective leaching, may result in iron being depleted leaving behind a graphite matrix with low mechanical strength. This type of leaching has similarities to bacterial corrosion which leads to the loss of additives in plastics. Microbial corrosion can also apply to plastics, concrete, and many other materials. Two examples are nylon-eating bacteria and plastic-eating bacteria.

Various corrosion inhibitors are available to combat microbial corrosion but have serious drawbacks. For example, benzalkonium chloride is commonly used in the oilfield industry. However, this compound is toxic and may be easily leached into the environment.

Bacterial and biofilm corrosion are types of corrosion promoted by chemoautotrophs, e.g., bacteria which use the corrosion process to gain energy. Biofilms are thought to be enhanced by bacterial colony formation tendencies with corrosion often being found under biofilms. Surfaces that have bacteria resident on them can be treated by short-term surface cleaning techniques to reduce or eliminate microorganisms and by techniques such as sterilizing, disinfecting or ultraviolet cleaning. Although it is commonly understood that biofilms aid corrosion, it is possible that select biofilms may in the future be also engineered to modify corrosion products, or to perhaps even suppress excessive corrosion by the right combination of alloys and bacteria. Gram −ve bacteria such as E. Coli and others are associated with some nosocomial infections. Gram +ve bacteria include microbes such as Bacillus, Listeria, Staphylococcus, Streptococcus, Enterococcus, and Clostridium. Such pathogens, particularly those related to nosocomial infections that reside on surfaces can cause significant health issues and related social expenditure. Open atmosphere conditions are often required for biofilm formation. However, Gram +ve and Gram −ve bacteria, may both be found in soils and water reservoirs, and both types can also lead to corrosion. In addition to bacterial colonies, biofilms may often have polysaccharides and various salts with some of these salts being present in sea water.

Biofilm based losses in the Energy and Transportation infrastructure are common occurrence. Biofilms are also the cause of corrosion in bio-implants with a specific and notable problem relating to stents used in bile ducts where biofilms can form and clog the duct. Specific and diverse bacterial colonies (communities) are linked to biofilms. Corroded steel sheet piling surfaces and corrosion tubercles have been found to be covered by complex microbial biofilms that formed from different bacterial phyla. The diversity of bacterial biofilm communities was different on steel pilings at highly corroded and less affected sites. The majority of bacteria on the surfaces of steel pilings at the corroded sites examined were from three bacterial phyla, Proteobacteria, and Cyanobacteria. Iron-oxidizing (S. lithoautotrophicus) and iron-reducing (R. ferrireducens) bacteria have been detected on corroding steel pilings. See: Liming Dai, Heather A. W. StJohn, Jingjing Bi, Paul Zientek, Ronald C. Chatelier and Hans J. Griesser, “Biomedical coatings by the covalent immobilization of polysaccharides onto gas-plasma-activated polymer surfaces”, Surface and Interface Analysis, 29, 46-55, 2000; Graff, M., and O. Seifert, ALWC on a jetty: “A Case History from Discovery to Repair”, Second International Conference on Accelerated Low Water Corrosion held at Liverpool, England, 5p, Jun. 21-22, 2005; Marsh, C. P., J. Bushman, A. D. Beitelman, R. G. Buchheit, and B. J. Little, “Freshwater Corrosion in the Duluth-Superior Harbor—Summary of the Initial Workshop Findings”, Special Publication ERDC/CERL SR-05-3, U.S. Army Corps of Engineers, 2005; K. Pedersen: Biofilm development on stainless steel and pvc surfaces in drinking water, Water Research, Volume 24, Issue 2, February 1990, Pages 239-243, 1990; and J. P. Chandyand M. L. Angles: Determination of nutrients limiting biofilm formation and the subsequent impact on disinfectant decay, Water Research, Volume 35, Issue 11, August 2001, Pages 2677-2682, 2001.

Apart from stainless steel, nickel, copper, iron based and other commonly used engineering alloys the transportation industry also uses PVC and other polymers. These too are prone to microbial corrosion. PVC degradation is due to a wide array of complex physiochemical processes. The most common form of degradation is related to a decrease in polymer chain length.

The use of nanoparticles for antibacterial activity has been reported, somewhat, in the literature. Silica nanoparticles offer an effective way of delivering nitric oxide (NO) into the cells to kill bacteria. Nitric oxide kills bacteria, as long as it is in contact with bacteria. Ag and Cu are toxic to bacteria; CuSO₄ is added to kill cyano bacteria in water supplies. Silver (Ag) nanoparticles are well known also and act by oxidation and denaturing. The silver prevents the bacteria from exerting any control on exposure to oxidation reactions. Nanosilver may also generate reactive oxygen in either air or water which affects the cell wall of bacteria in much the same way any strong base, such as Hydrogen Peroxide, to kill bacteria. Ag is used in many ways, e.g., in silver sulfadiazine (1% in cream) which is a method in which burns are treated to prevent infection and scarring. A denaturation mechanism has also been proposed, e.g., where disulfide bonds in a protein (enzyme) are cleaved or disconnected, thus leading to anti-viral activity. However, this mechanism is expected to be strongly operative for particles around 10 nm and lower in size as this size of the particle and active cell molecule are then of the same order. The 316L is a commonly employed stainless steel that is used in the transportation, health-care and energy sectors. The problem with most nanoparticles is that they may leach out as particles. A tightly bound and adherent nanostructured surface is needed and is presented in this application.

### SUMMARY

The use of nanoporous nanostructures as bacterial colony modifiers is discussed for the first time in this application. Also for the first time, biofilm modification and elimination by a nanoporous nanostructure is shown. The nanostructures presented here are defined as being nanoporous nanostructures and are considered as such when referred to throughout this application. Nanoporous nanostructures are composed of a regular organic or inorganic non-porous framework supporting a porous structure where the individual pores (nanopores) are nanoscale (i.e., less than 1000 nanometers in one direction) or sub-micron in size. It is anticipated that the framework could be a structure defined, but not limited, as being thin walled, thick walled, skeletal, scaffold-like, multiphase, webbed, sponge-like, wood-like, high-density, low-density, uniform, non-uniform, graded or non-graded. The non-porous framework may be comprised of nanoparticles of various shapes which can be composed of, for example, molybdenum and silver compounds. In other words, a nanoporous nanostructure is a material composed of a non-porous framework formed of nanoparticles, throughout which, nano-scaled pores are supported.

The results here are restricted to stainless steel substrates with high efficacy MoSi₂ and Ag comprising the non-porous framework of the nanoporous nanostructures, but they are also descriptive of combinations of nanoparticles that comprise at least one of: silver, tungsten, iron, carbon, aluminum, copper, nickel, iron, SiC, SiO₂, an oxide of at least one of nickel, iron, tungsten, or chromium, Cu, Ag, Au, Pt, Pd, Ir, a rare earth metal, a semiconductor, B, Si, Ge, As, La, Sb, Te, Po, an iron oxide, a tungsten oxide, a chromium oxide, VₓO_{y}, FeₓO_{y}, FeOₓ, FeₓO_{y}, aluminum oxide, NiO, zinc oxide, tin oxide, hafnium carbide, tungsten carbide, MnOₓ, SiOₓ, MoOₓ, HfOₓ, WOₓ, TiBₓ, CrOₓ, NbₓO_{y}, AlₓZr, BₓC, SiOₓ, ZrSiOₓ, BₓO_{y}, CdS, MnS, MoSₓ, NaNₓ, NaCN, SiₓN_{y}, PbO, Pbₓ, WOₓ, WOₓ, BaOₓ, SiOₓ, NiFeₓO_{y}, MoSₓ, FeMoSₓ, FeₓNO_{y}, AlₓO_{y} and a further defect compound, where x and y represent non-integer values, or at least one of an oxide, a carbide, a nitride, an aluminide, a boride, a silicide, or a halide of at least one of Cu, Ag, Au, Fe, Si, W, Mo, Ti, Hf, Pt, Pd, or Ir and all combinations or mixtures thereof that comprise the non-porous framework of the nanostructure (See PCT/US07/85564). The nanoporous nanostructure is comprised of nano-objects (defined as including, but not limited to, nanopores and nanoparticles) that are envisioned as having a sub-micron average size (less than 1000 nm or nanoscale) with large or small radii of curvature. The nano-objects that compose the nanoporous coating may be both smooth and sharp in configuration. In order to test the adherence of the nanostructure to the substrate standard ASTM single point scratch dynamic tests were conducted to determine the abrasion resistance of the nanostructured coatings and their efficacy following abrasion.

In this application, only stainless steel substrates are discussed in reference to the molybdenum disilicide nanostructure, but it is anticipated that other substrate materials and surfaces (solid and liquid) including, but not limited to aluminum, copper, nickel, plastic, PVC, wood, glue, paint, cement and other metallic and non-metallic alloy materials may also have the nanoporous nanostructure applied with the same antibiofilm results. Antibiofilm is here defined as the modification, destruction, elimination or control of biofilms or the prevention of their formation. Also here, antibiofilm is considered as including the modification, destruction, elimination or control of bacteria, fungus and microbes in general and any of these or other organisms that could result in the formation of biofilm. As such, the terms antimicrobial, antifungal and biocidal are considered as synonyms of antibiofilm when used in this application.

Nearly any surface may be coated and protected in this manner. Although silver and MoSi₂ are found to be strongly biocidal, the majority of discussions relate to MoSi₂. It is noted that this nanostructure is extremely adherent. The apparatus and process described here relate predominately to nanostructured surfaces composed of Ag or MoSiₓ+Ag, or MoSiₓ+Ag+Sic or Ag+SiC. The nanoporous nanostructured coating is also anticipated as being composed of multiple layers of nanoparticles. These nanoparticles may be composed of MoSi₂, Ag or other materials and arranged in a nanoporous structure having a chemical gradient, such as but not limited to, from MoSi₂ to Ag with a mixture of the two materials in various percentages between. In another embodiment the anticipated applied nanocoating may be of an inorganic material and will be a nanoporous nanostructure.

However, other embodiments including partly polymeric, partly ceramic and partly metallic nanoparticles that are effective as antimicrobial and biocidal materials are anticipated by the inventors as well. These suggested embodiments are not intended to be construed as limiting in scope and are meant to present exemplary embodiments of apparatus and methods useful in the elimination, control and prevention of microbial growth and biofilm formation on surfaces.

Recent problems stemming from the Gulf of Mexico oil spill can be addressed by the nanostructured coatings presented in the present application. When dispersant was applied to the oil spill, the oil was broken into small droplets that were eaten by bacteria. These bacteria then evolved into unknown types of bacteria which were pathogenic. The nanostructured coatings discussed here are able to eliminate all bacteria including all taxonomic ranks (domain, phylum, class, order, family genus and species, see Willey, J. M., Sherwood, L. M. and Woolverton, C. J.; Prescott, Harley and Klein's Microbiology, 7th ed., McGraw Hill 2008), known and unknown including these new evolving pathogens and resulting biofilm. The nanoporous structures presented here can modify biofilms biostatically, as well in a biocidal fashion, through the changing of the morphology (shape) of the biofilm. Also, any travel or movement of a biofilm may be modified as well by the presented structure.

Discussed in this application are unique nanostructured MoSi₂ on 316L stainless steel surfaces which are noted to diminish bacterial colony formation of several Gram+ve and Gram−ve bacteria. Similarly created nanostructures on PVC and other surfaces are anticipated by the inventors. The entire gamut of pathogens and non-pathogens is covered. Bacteriophages are also implied by the use of the term microbial.

### BRIEF DESCRIPTION OF THE DRAWINGS

FIG. 1 is an illustration of an arc electrode apparatus which may be used to produce antibiofilm nanoporous nanostructures in accordance with certain exemplary embodiments described in the present application.

FIG. 2 is an illustration of large substrate arc electrode apparatus which may be used to produce antibiofilm nanoporous nanostructures on large substrates in accordance with embodiments described in the present application.

FIG. 3 is an illustration of a containment arc electrode apparatus which may be used to produce antibiofilm nanoporous nanostructures on surfaces and objects within a closed container in accordance with embodiments described in the present application.

FIG. 4 is an illustration of a conveyance arc electrode apparatus which may be used to produce antibiofilm nanoporous nanostructures on objects and surfaces moving on a conveyor belt in accordance with embodiments described in the present application.

FIG. 5 is a figure illustrating the comparative efficacy for colony formation on nanoporous nanostructures made from nanoparticles comprised of Ag, MoSi₂, C, Cu, Al, W and Ti and their various oxides, alloys and mixtures thereof.

FIG. 6 is a SEM secondary electron image of the as deposited MoSi₂, (Molybdenum disilicide) deposited nanoporous nanostructure on the 316 surface produced in accordance with the embodiments described in the present application. The nano-objects are faceted, but there is likely to be smooth surfaces with a corresponding curved high curvature from the small radii of the nanopores.

FIG. 7 is an image provided by a transmission electron microscope (TEM) of an antibiofilm nanoporous coating produced in accordance with embodiments of the apparatus described in the present application.

FIG. 8 is another TEM image of a further example of an antibiofilm nanoporous coating produced in accordance with embodiments of the apparatus described in the present application.

FIG. 9 is an image provided by a scanning electron microscope (SEM) of an antibiofilm nanoporous coating produced in accordance with embodiments of the apparatus described in the present application.

FIG. 10 is another SEM image of a further example of an antibiofilm nanoporous coating produced in accordance with embodiments of the apparatus described in the present application.

FIG. 11A is an image of MoSi₂, nanoporous nanostructure coated stainless steel Nano-5T(MoSi₂,) produced in accordance with embodiments described in the present application which is free from fungus after a 2 hour contact time and 48 hour incubation.

FIG. 11B is an image of uncoated stainless steel showing fungus like morphologies after 2 hour contact time and 48 hour incubation.

FIG. 12A is an image showing a nano-5T(MoSi₂,) coated substrate in accordance with the present application. E-Coli growth is not observed on the substrate indicating the presence of antibiofilm activity.

FIG. 12B is an image showing an uncoated substrate. E-Coli growth is observed on the sample indicating the absence of antibiofilm activity.

FIGS. 13A-13F are images of the optical microstructures of uncoated stainless steel 316L surfaces inoculated with Enterobacter Aerogenes and nutrient swabbed within 24 hours showing biofilm formation. Such surfaces coated in accordance with the embodiments of the present application did not show any such biofilm growth features.

FIG. 14A is a drying curve comparing coated and uncoated substrates and indicating the differences between them at room temperature of 19° C. (66° F.), with 45% relative humidity

FIG. 14B is a graph illustrating bacterial activity versus spread rate of a water droplet on a similarly constructed substrate surface.

DRAWINGS - Reference Numerals

| | | | |
|---|---|---|---|
| 1 | high frequency power source | 2 | electrode |
| 3 | coil | 4 | capacitor |
| 5 | capacitor | 6 | capacitor |
| 7 | carrier gas | 8 | electrical discharge |
| 9 | ionic particles | 12 | substrate |
| 16 | deposition arrangement | 17 | translating arrangement |
| 18 | enclosure | 19 | object |
| 20 | conveyor belt | 21 | plurality of objects |

| | |
|---|---|
| 100 | arc electrode apparatus |
| 200 | large substrate arc electrode apparatus |
| 300 | containment arc electrode apparatus |
| 400 | conveyance arc electrode apparatus |

### DETAILED DESCRIPTION

Exemplary embodiments of the present invention can provide durable nanoporous nanostructures with antibiofilm properties. Such structures can include, e.g., microscopic and/or nanoscale (i.e., 1 mm=1000 microns [μm]=10⁶ nm or 1 μm=1000 nm) particles of certain materials which may be strongly bonded to a substrate and/or to each other. Preferred nanostructures are nanoporous (i.e., have pores less than 1000 nanometers [i.e., sub-micron] in size) and are comprised of nanoparticles of MoSi₂ and/or similar materials and mixtures thereof which may be inorganic and when applied as a coating have a nanoscale thickness. The coatings may be porous or otherwise not fully sintered or densified. Anticipated techniques allow for multi-compositional structures and layers with different compositions. Mixed mode coatings, i.e., nanoporous and chemical gradients are possible. The nanoporous structures may be chemically or mechanically active or have a potential gradient (i.e., a gradient in charge, solute, magnetism, electrostatics, heat, etc. through the structure).

Such nanoporous nanostructures may be formed using exemplary techniques described in U.S. Pat. No. 7,880,119 and International Patent Applications Nos. PCT/US06/60621 and PCT/US07/85564 the entire disclosures of which are incorporated herein by reference in their entireties. Such exemplary techniques which may be used to produce nanostructures of nanoparticles are described in more detail herein, and can be used to provide nanoporous nanostructures which, surprisingly, exhibit antibiofilm properties.

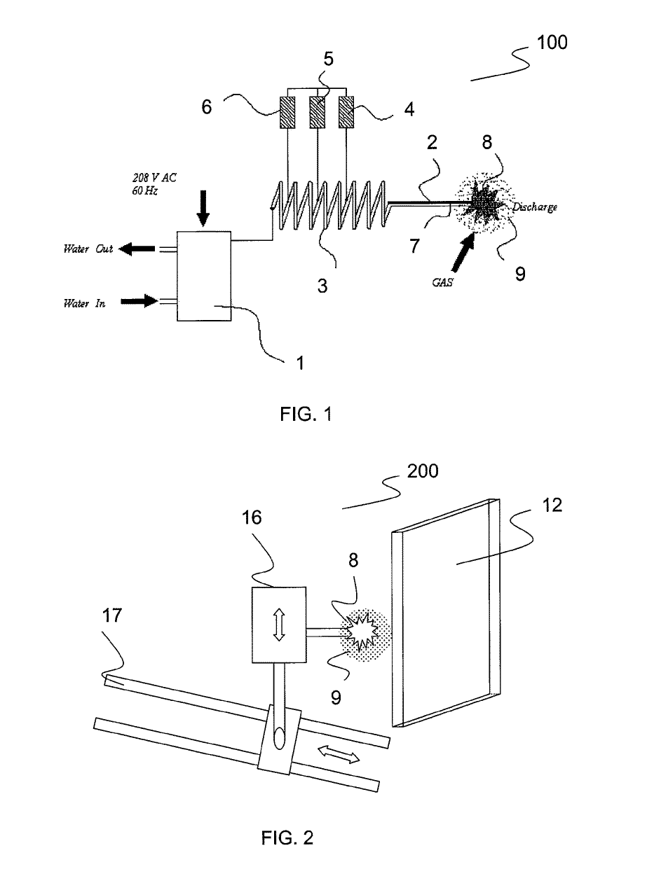

An arc electrode apparatus 100 which can be used to produce antibiofilm nanoporous nanostructures in accordance with exemplary embodiments of the present invention is shown in FIG. 1. The apparatus 100 can be configured to produce an electrical arc or discharge 8 at a distal end of an electrode 2, where the arc or discharge 8 can be produced without the distal end of the electrode 2 being in proximity to an electrically grounded object.

For example, the apparatus 100 can be based on a one-sided electrode arrangement which may be configured to produce a nanoporous nanostructure comprised of a non-porous framework composed of nanoparticles which delineate nanopores. The apparatus 100 may be comprised of a high-frequency electrical generator or power source 1, a conductive coil 3 which may be provided as a coiled tube, and can be formed, e.g., using copper or another conductive material, and an electrode 2 which can be formed of or include a material to be deposited as at the non-porous part of a nanoporous nanostructure. The electrode 2 may be conductive or semi conductive. Capacitors 4, 5, 6 can be provided in an electrical communication with the conductive coil 3, which may exhibit electrically inductive properties. For example, capacitors 4, 5, 6 and coil 3 may together form a conventional Pi circuit, or exhibit electrical behavior similar to such circuit. A carrier gas 7 may also be provided adjacent to the electrode 2.

When the arc electrode apparatus 100 is operated, an electrical arc or discharge 8 may be produced near a distal end of the electrode 2, and ionic particles 9 may be emitted from the electrode 2. Such particles can be expelled onto a nearby substrate and may adhere to such substrate, forming a strong mechanical bond. Such particles may also be expelled forming a nanoporous nanostructure that is not attached to a substrate. A substrate for the particles to adhere to as a coating is not necessary for the formation of the antibiofilm nanoporous nanostructure. The beneficial antibiofilm properties are present without the inclusion of a substrate. The electrical arc or discharge 8 can be produced from the distal end of the electrode 2 using such exemplary one-sided electrode apparatus 100, even if the distal end of the electrode 2 is not proximate to an electrically grounded object. Thus, the electrical arc or discharge 8 may be produced in proximity to electrically nonconductive substrates, in contrast to conventional arc welding systems and the like.

A large substrate arc electrode apparatus 200 is shown in FIG. 2 which can be used to provide a nanoporous nanostructured antibiofilm coating on a large substrate 12. The apparatus 200 can include a deposition arrangement 16, which may be configured to produce an electrical arc or discharge 8 and emit ionic or other particles 9. The deposition arrangement 16 can be affixed to a translating arrangement 17, which can controllably move the deposition arrangement 16, e.g., along or over at least a portion of a large substrate 12. Thus, particles 9 can be deposited on a large substrate to form an antibiofilm coating thereon. The translating arrangement 17 can include or communicate with a controller (not shown) which can control the position and/or speed of the deposition arrangement 16 relative to the substrate 12. Thus, the location and amount of deposited coating formed by the particles 9 can be controlled. For example, such controller can control a position of the distal end of the electrode 8 relative to the substrate 12, e.g., provide a substantially constant distance between them, which can further allow a more uniform deposition of particles 9 on the substrate 12. The substrate 12 can be any surface of any object for which antibiofilm protection is desired.

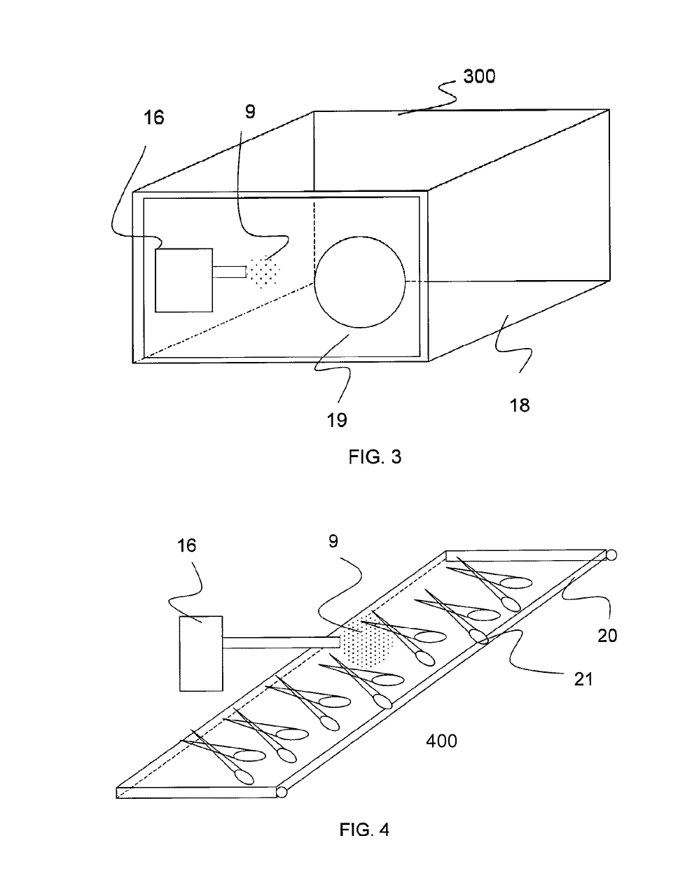

A containment arc electrode apparatus 300 which can be used to provide a nanoporous nanostructured antibiofilm coating is shown in FIG. 3. The apparatus 300 can include the deposition arrangement 16, which (as described above) may be configured to emit particles 9. The deposition arrangement 16 can be provided at least partially inside an enclosure 18, and the enclosure 18 can further enclose an object 19 to be coated with an antibiofilm coating. When using the apparatus 300, the particles 9 can be deposited on an object 19 to form an antibiofilm coating thereon. Further, any of the particles 9 which are not deposited on the object 19 may remain in the enclosure 18. This exemplary configuration can assist in recovering such particle material, which may be then be reused or recycled.

A conveyance arc electrode apparatus 400 which can be used to provide a nanoporous nanostructured antibiofilm coating is shown in FIG. 4. The apparatus 400 can again include the deposition arrangement 16, which is configured to emit the particles 9. The deposition arrangement 16 can be provided in proximity to a conveyor belt 20 or similar transport apparatus. A plurality of objects 21 to be coated with an antibiofilm coating can be provided on the conveyor belt 20. When using the apparatus 400, particles 9 can be continuously deposited on a large number of objects 21 to form an antibiofilm coating thereon. System parameters, such as speed of the conveyor belt 20 and intensity of discharged particles 9, may be adjusted to provide a suitable amount or thickness of the coating on the objects 21.

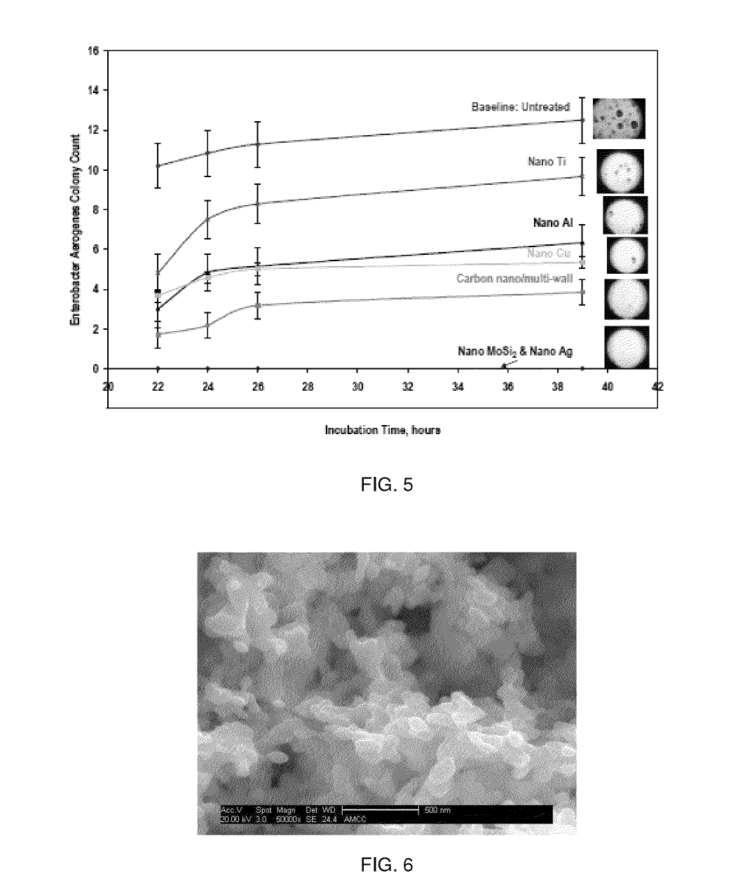

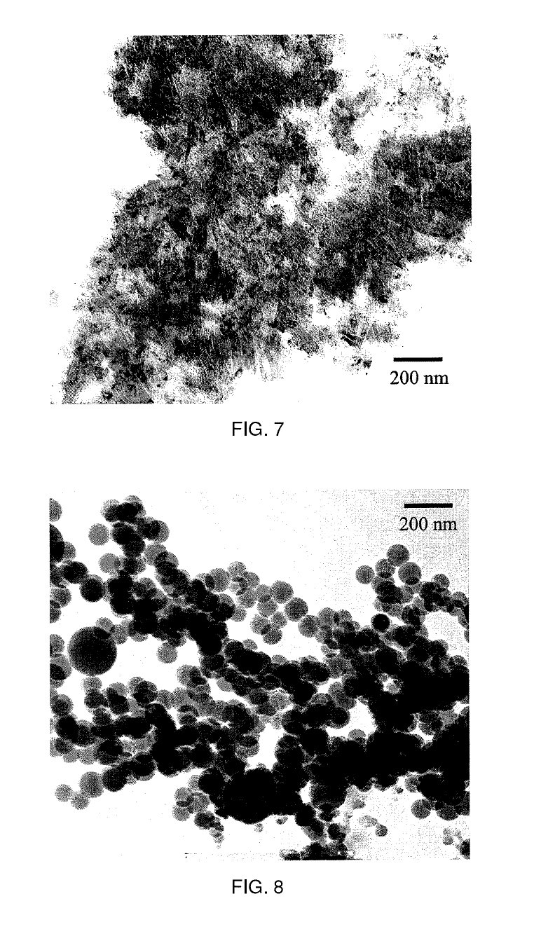

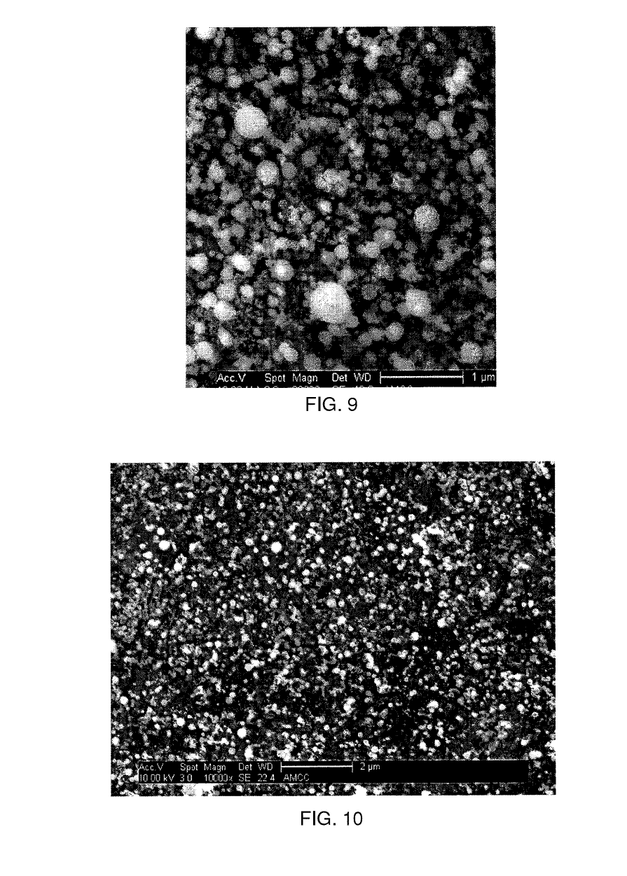

As stated, the nano-objects of the nanoporous nanostructure were applied to the surface of a stainless steel substrate with the arc electrode process described in detail in incorporated references U.S. Pat. No. 7,880,119, and International Patent Applications PCT/US06/60621 and PCT/US07/85564. All electrodes were of at least 99.9% purity. For the first level of screening Al, Ti, carbon nanotubes, MoSi₂, Cu and Ag were deposited on stainless steel to form a nanostructured coated surface. The coating thickness ranged from about 300-1000 nm. The SEM characterized surface of a typical nanostructure of MoSi₂ on stainless steel 316L is shown in FIG. 6. The nanoparticles which form the nanostructured surface retain an open porous structure (see FIG. 6 for MoSi₂). In the published literature, several types of nanostructure production methods including oscillatory and high pressure methods for bulk alloys and large area coatings have been discussed for metallic, semiconductor and intermetallic type nanoparticles and nanoporous structures. The estimate based on the SEM surface photomicrographs for the average MoSi₂ particles as well as the other particles presented in FIG. 5 are about 1-100 nm in size and for particles (typical surface shown in FIG. 6). Bacteria on the other hand are about or greater 1000 nm in size, cancer cells are larger, whereas prions and viruses (20 to 400 nm) are smaller. Coatings of less than 1000 nm in thickness are anticipated as well.

Testing for the antibiofilm nature of the surfaces was done for flat surfaces of Ag, and cold rolled (1 mm thick) 316L stainless steel. Then the nanoporous nanostructured coating on the rolled 1 mm thick 316L stainless steel surfaces all cut to an area of approximately of 25 mm×25 mm was tested. The flat MoSi₂ surface was available only in the form of discs of 6 mm diameter and so an equivalent area in the form of several discs was used. Through testing it was determined that a better and more effective bioactive nature was achieved through the use of nanosize particles and nanostructures as compared with larger sized particles and structures. Nanoparticles with both low radius and high radius configurations were tested and each had superior results when compared with surfaces with larger than nanoscale particles.

The following four antimicrobial tests were performed: 1) AOAC test procedure 988.18 and/or 989.11; 2) ASTM E 2149—Standard Test Method for Determining the Antimicrobial Activity of Immobilized Antimicrobial Agents under Dynamic Contact Conditions; 3) JIS Z 2801—Japanese Standard Test for Antimicrobial Product Activity and Efficacy); and 4) Kirby-Bauer type Zone of Inhibition (ZOI) Testing (AATCC-147-2004).

The AOAC procedures are discussed below in detail as this method is not as standard as the agar colony tests. We find that these AOAC tests are reliable for comparing colony formation results from various surfaces. The AOAC method also provides an easy quantitative comparison between various tests surfaces. For the AOAC test, a sterilized (cotton applicator) swab is dipped into a bacteria containing solution and inoculated on the test surface by swabbing. After the required residence time on the surface (surfaces were kept in open laboratories not sterilized labs), a sterilized swab was dipped into the nutrient containing liquid test medium bottle to moisten. The moistened applicator was then re-swabbed on the inoculated surface and inserted back into previously opened liquid test medium bottle and twirled for 2 minutes repeatedly against the inside of the bottle to break loose any test materials such as bacteria or spores into the nutrient-containing liquid medium. The (cotton applicator) swab was removed from the bottle (any excess liquid medium on the inside of the bottle being squeezed out) and the contents were poured into the bottom of the sterilized and previously sealed Petri dish with lids. The commercially available nutrient-containing medium contained a tetrazolium salt (triphenyl type) which caused colonies growing in the medium to appear as pink/red dots. The staining with tetrazolium salts is a powerful method for the color based study of a variety of microbiological processes including, protein folding, signal transduction, DNA metabolism and electron transfer. The lid was replaced and contents swirled gently so that the liquid covered the bottom of the Petri dish completely. The Petri dish was left to stand undistributed on the level work table until the medium was solid (took approximately one hour). The assembly was placed in a chamber of 35±1° C. monitored by a thermometer. The Petri dish plates were checked periodically, to count the number of pink-red colonies growing in/on the medium. A bacteria count for the bacterial colonies was made visually for each Petri dish. Incubation was carried out for 24 hrs or longer at 35±1° C. The temperature of incubation was measured with a thermometer model #TAYLOR 6092-1 which was accurate to about 1° C. The bacteria colonies were also counted at 40× with a polarized microscope at various time intervals, during colony incubation periods which included measurements at 22, 24, 26, and 39 hours. The number of colonies observed in a field of view of the image was recorded for each tested surface. Six different locations of each Petri dish were used to obtain the colony counts. An average of the colony counts was reported at each time interval. A graph showing the results of this analysis for various nanostructured surfaces is shown in FIG. 5. Novel quick tests are also introduced in this application. Preliminary viral tests were also done with select Bacteriophages (viruses that infect bacteria) to gauge the virucidal efficacy.

Unless the dish was full of red tiny red dots (signifying very high levels of bacterial concentration) every pink/red dot that appears was tediously counted. Counting was carried out by looking through the bottom of the plate and using a fine point magic marker to make a dot on the plate over each colony as it is counted or by observing in a stereo-microscope. For biocidal materials, individual dots could be easily counted, but for non-biocidal surfaces, the test dish could have hundreds to several thousands of colonies (in fact, it may have so much contamination that the medium in Petri dish looks a lighter pink and it could be difficult to see individual colonies). The swab test provided for good transfer of the organisms present, unlike the standard agar streaking test which resulted in poor separation of the organisms so that instead of colonies growing from individual organisms, one tends to get streaks or smears which are undistinguishable. All quantitative reports below are to be considered only in such a comparative manner. No additional antibiotics or functionalization by other drugs was introduced to any surface although the inventors realize their additional value.

Surface adherence and characterization analysis was also performed. ASTM scratch tests and other wear tests were carried out for simulating the scratches or rubbing of the surface over a period of time. A scanning electron microscope was used for examining the surfaces. We show below that a simulated rubbing action which was also performed on the surfaces sometimes could lead to biostatic behavior. All antimicrobial and biofilm tests reported in here were only done in relatively static fluids, but results are applicable to non-static situations.

In lieu of detailed and expensive AFM (Atomic Force Microscope) and EM (Electron Microscope) analysis we have also developed a quick test that involves placing a 0.020±0.005 ml distilled water droplet on the surface and studying its spreading and drying behavior to assess the presence of nanostructures on the surface. The water droplet was introduced with a graduated pipette. This test was found to be a reliable differentiator of the three types of surfaces. The droplets were released from a height of about 3-5 mm above the surface. Each type of surface showed very different but reproducible drying rate, and spread rate which are discussed below. The clear correlation of the drying rate, and spread rate with bioactivity is also discussed below. In this application, two types of nanostructure surfaces (one as deposited and the other after simulated wear) are compared with uncoated surfaces. The coated surface is labeled Nano-5T (ss316L), i.e., identified with the chemistry in parenthesis. Nano-5T is here defined as being a nanoporous nanostructure whenever referred to throughout this application. Original-5T(ss316L), Original-5T(Ag), and Original-5T(MoSi₂) are respectively surfaces of the uncoated SS316L sheet, Ag sheet, and MoSi₂. Yet another surface was obtained by rapidly passing a high fiber soft cotton cloth about 100 times over a Nano-5T sheet to simulate a rubbing type of wear on the original nanostructured surface. These surfaces will be referred to as Nano-5T-RO.

After the initial screening (FIG. 5) flat surfaces (polished to 0.3 micron smoothness) of 99.9% purity Ag, MoSi₂ and commercial stainless steel 316L were tested against each other. Comparisons were made of the colony formation from the three surfaces with the AOAC test described above for Enterobacter Aerogenes and Bacillus Cereus for a two hour contact time. This test was done with the room set at 25° C. and 51% Relative Humidity. It was immediately observed that in comparison to silver and MoSi₂ the uncoated stainless was very weak in any biocidal behavior. All experiments had the same initial starting cfu (colony forming unit) concentrations (−10⁶ cfu's/ml) and were tested simultaneously on the same date. Heavily populated colonies (>10,000) were seen on the stainless steel 316L (3(a) and 3(d)). The biocidal activity of stainless steel 316L was very weak for both bacteria, while both Ag and MoSi₂ were strong. The antibacterial efficacy for the MoSi₂ nanostructure was stronger for Bacillus Cereus (Gram +ve) compared to silver and slightly lower for the (Gram +ve) Enterobacter Aerogenes. A combination of nanoparticles is anticipated. The incubation for 24 hours was done at 35±1° C. Clear bactericidal action was noted for silver and MoSi₂. The strict definition of bactericidal should mean that there are no viable endospores left. Here, a material is bactericidal if in 24 hrs of incubation at 35 C there is at least a 10³ reduction of colonies. (Note that a typical 0.1 mm colony may contain over 10⁶ bacteria of a 1 micron radius bacterial species). Bacteriostatic action is inferred if significant variations in the morphology of colonies or in the overall mean size of colonies is noted regardless of whether the number of colonies was not zero at the 24 hr. It will be shown below that for nanostructured surfaces the number of colonies were often zero at the 24^{th} hour.

Studies have indicated that for the Enterobacter Aerogenes, the Lag phase prior to first colony formation is higher by four hours for silver compared to MoSi₂ but considerably more for both when compared to the stainless steel. The lag phase indicates a delay in the cell division process, and for identical conditions, could indicate a depletion of ATP or ribosomes or redox reaction modification in the cells (cells here are defined throughout as biological cells). The inoculants were not refrigerated. Refrigeration can also increase the Lag phase. A bimodal distribution of cells is seen. The growth kinetics is very rapid for stainless steel exposure (similar to what one would get from the inoculant itself).

The nanostructure coatings have an open pore structure as shown in FIG. 6 for the MoSi₂ nanostructure. Only limited EDAX/EDS were conducted as the beam always sampled a part of the base stainless steel 316L which has a nominal composition of 17% Cr-12% Ni-2.5% Mo—Fe. The composition of the coating that is reported in this article corresponds to the electrode only. For the non-pathogen tests, (Gram +ve) and (Gram −ve) bacteria contained in the liquid media (approximately ˜10⁶/cc) were swabbed onto surfaces of the coated stainless steel substrates, i.e., on to the Nano-5T, Nano-5T-RO and also on the uncoated stainless steel (Original-5T) for comparison for each run. The bacteria were allowed to remain on the surfaces for exactly 2 hours of contact time. The coated and uncoated surfaces were inoculated with: (i) Gram (−ve) bacteria Enterobacter Aerogenes, and (ii) Gram (+ve) bacteria Bacillus Cereus. Bacteria count was made from swabs taken from both coated and uncoated surfaces. In some instances the proliferation of colonies was extremely rapid and the Petri dish was abundantly covered with red color stained colonies within four to six hours which prevented small cell clusters growing into larger colonies.

For both Enterobacter Aerogenes and Bacillus Cereus after 2 hours of contact with a nanostructured surface and 24 hours of incubation the nanostructured silver had no visible colonies whereas the uncoated had a myriad of colonies as described in Tables 3A and 3B. The Nano-5T-RO(Ag) surfaces were found to be also fully bactericidal with zero colony formation in 24 hours incubation after the 2 hours of contact time. Similar results are noted and shown for MoSi₂ in Tables 3C and 3D. A comparison with the flat polished surface, namely of Ag or MoSi₂ is also provided in each table. It is clear that nanostructured surfaces of the same agent always showed a great Lag phase and a smaller number of colonies, thus indicating the influence of curvature on biocidal efficacy. The distribution was always bimodal with the majority cells always distributed in the smaller mode. The clear result is that nanostructured surfaces show significantly greater efficacy compared to flat surfaces of the same materials. From the limited research available, it appears that curvature influences catalytic activity in an unanticipated manner. An unanticipated result is also noted: The rate of bacterial growth on the RO surfaces is slower than the as-coated, Nanosurfaces for MoSi₂.

Bacteria count in (i) 1 g topsoil, (ii) normal concentration topsoil solution (30 g topsoil in 70 ml tap water) and (iii) high concentration topsoil solution (60 g topsoil in 70 ml tap water), and (iv) tap water samples were tested at an external laboratory for bacteria count and bacterial identification via DNA. The bacteria and concentrations in tap water that were found are given as: 1) Topsoil mixed with sterilized water and tested for colony count immediately after mixing soil and water: 4.00E+05 cfu/ml at 0 hour; 2) Normal Concentration, 30 g topsoil in 70 ml tap water, 1.54E7 cfu/ml tested at 52^{nd} hour after mixing with tap water; 3) High Concentration, 60 g topsoil in 70 ml tap water, 3.08E7 cfu/ml tested at 52nd hour after mixing tap water; and 4) Tap Water, Less than 5 cfu/ml tested at 52^{nd} hour.

The drinkable quality of tap water itself that showed less than 5 cfu/ml was insignificant compared to the top soil plus tap water concentrations. The following bacteria were identified in the topsoil (see concentrations in the caption of FIGS. 5 (a-c)); Arthrobacter Globiformis (Gram +ve) with morphology of irregular rods and small cocci, Bacillus Megaterium (Gram +ve) with morphology of rods, and endospore forming; and Cupriavidus Necator (Gram −ve) with morphology of Coccoid and irregular rods.

For MoSi₂ nanostructured surface, bactericidal, biocidal and bacteriostatic actions were noted with the topsoil inoculant (high concentration). It is anticipated that contact time could be within seconds for efficacy.

The possible origins of antimicrobial properties are discussed below. Limited investigation to date appears to indicate that the nanostructure coatings perform a nanoscale chemical and possible nanoscale mechanical action for bacterial elimination. As is noted below the MoSi₂ nanostructure coating acts equally well in low humidity and high humidity situations.

MoSiₓ may cause NO or other oxidizers to form on contact with the bacteria. NO enters the cell and disrupts it. Color differences in the treated surface colonies and untreated surface colonies indicate that redox reactions may have been influenced by the nano particles. This process is called redox signaling. Cells in biofilms often show distinct patterns of gene expression (phenotypic differentiation) in time and space. Also, like multi-cellular eukaryotes, these changes in expression appear to often result from cell-to-cell signaling, a phenomenon known as quorum sensing. At least 50 molybdenum-containing enzymes are now known in bacteria and animals, though only the bacterial and cyanobacterial enzymes are involved in nitrogen fixation. Active species of oxygen and nitric oxide can also act as cellular messengers. It is possible that the nanostructure influenced the signaling. Once disrupted, colonies cannot form quickly and at least a longer lag phase is to be expected.

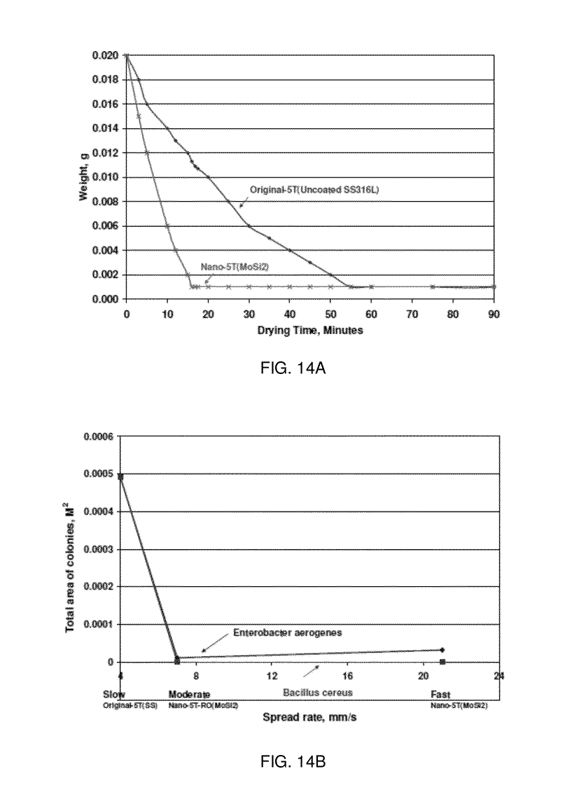

MoSi₂ nanostructures display much lower contact angle for a water droplet placed on the surface (see Table 6). This rapid dispersion of water coupled with a high drying rate (low humidity scenario) FIG. 14A, could starve the bacteria or mechanically rupturing dried cells (a hypertonic situation created by drying). A much faster drying has been observed on surfaces coated with the MoSi₂ nanostructure coating when compared to uncoated stainless steel. In comparison that there are reports that silver are not effective in low humidity conditions. FIG. 14A shows the drying rate of 0.020 g droplet of water placed on a stainless steel substrate with and without the MoSi₂ nanostructure. The conditions of drying that have been studied are shown in Table 6. FIG. 14B is a plot of total area of colonies after 24 hours as a function of spread rate for the Nano-5T(MoSiₓ), Nano-5T-RO(MoSiₓ), where x could be 2, and bare stainless steel Original-5T. Spread rates were characterized as slow, moderate and fast. In general for a particular chemical the spread increases with nanoparticle coating (porous nanostructuring). For all the flat uncoated surfaces, i.e., Original-5T (stainless steel flat), Original-5T (MoSiₓ flat) and Original-5T (Silver flat), the spread rate was almost equal and fell in the slow category.

It could be possible that nanostructures of the type described in this application cause the bacteria in contact with the surface to swell (high humidity scenario) and explode because of the swelling (hypotonic situation). An increase in the relative surface area accompanying an increase in volume without a change in shape is possible during cell swelling. Swelling and bursting due to entry of water is caused by exposure of cells to a hypotonic medium relative to that of the cell content or an increase in passive diffusion of cations, such that the Na/K (sodium/potassium) pump cannot maintain an asymmetric intracellular/extracellular distribution. The Na/K balance of a cell is thus impacted by the nanoporous nanostructure leading to antibiofilm behavior. The increase in surface area comes from motion of microtubules or disruption of pili or flagelum. The cells inflate and finally burst because the thin membrane cannot withstand the high pressure inside the cell.

It is clear that biomolecular kinetics can be influenced by the nanostructures. Silver and MoSi₂ show very strong bactericidal action for the 2 hour contact time for both the Gram(+ve) Bacillus Cereus and Gram(−ve) Enterobacter Aerogenes. Other nanostructures show less efficacy for the same contact period as shown in FIG. 5. In the case of top soil for a contact time of 2 hours, the MoSi₂ appears to indicate bacteriostatic action whereas the silver remains strongly bactericidal but only in the nanocoated nanostructure state. With an increase in the contact time the bactericidal action (measured by lag phase increase) increases for nanostructured MoSi₂— top soil bacteria. Contact times of seconds to hours are anticipated.

Four nanostructure coated stainless steel 316L coupons of size 25×32×1 mm were subjected to virus Phi 6 Bacteriophage (HB10YB) with a host microbe of Pseudomonas Syringae (HB10Y), in accordance with the standard JIS Z 2801:2000. Coated and uncoated surfaces are compared in table 1. The nanostructured surface was able to eliminate the bacteriophage completely, as shown.

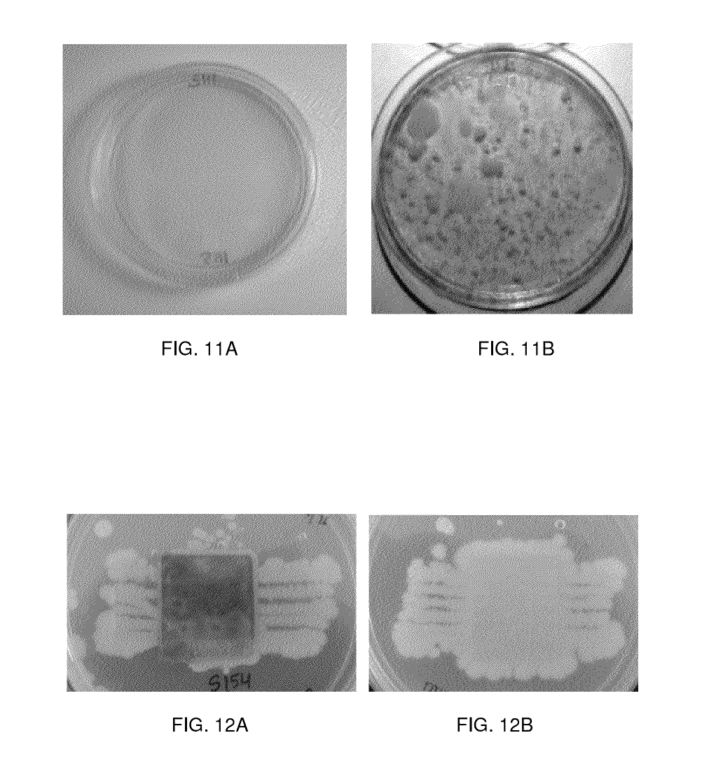

The tests also reveal the fungus like morphologies if the Petri dish (FIGS. 11A and 11B) is observed beyond 48 hours. For a 48 hour duration FIGS. 11A and 11B compare Nano-5T(MoSi₂) and Original -5T results. The tetrazolium salt does not color such fungal colony morphologies. Note that the MoSi₂ nanostructure coated stainless steel as well as all nanoporous, nanostructured, nanocoated 316L is free from this fungus like morphology, while the FIG. 11B shows fungus like morphologies for an uncoated stainless steel 316L. Such results were repeated noted for MoSi₂ nanostructured surface. Although not fully studied, it was noted in a particular experiment that in comparison the silver nanoparticles display less of the same antifungal behavior.

The Kirby Jones standard zone of inhibition test was employed for testing against pathogens for Silver and MoSi₂. A comparison of results from Nano-5T (MoSi₂) and Original-5T(SS316L) that were subjected to the JS:2801 Zone of Inhibition antibacterial test at external laboratories is shown in FIGS. 12A and 12B. The coated surfaces and uncoated were inoculated with the bacteria as per the standard. No growth was noted on the coupon FIG. 12B (Nano-5T), whereas in comparison the uncoated coupon (original-5T(ss)) showed growth and no zone-of-inhibition, as shown in FIG. 12B. All standard precautions for sterility were taken during the testing as is called out in the standard. Both MoSi₂ and Ag exhibited very strong antibacterial (bactericidal) action as was previously noted in the results shown in FIG. 5. Silver showed about a 6 mm zone of inhibition and the zone was much narrower for MoSi₂. These results point to a stronger chemical effect from dissolving and migrating silver ions compared to the MoSi₂ at least for the duration of this test.

Scratch resistance tests in accordance with the ASTM E 2546 standard are routinely carried out to test for the adherence of nanocoatings using a Nano Scratch Tester. Scratch test results revealed none of the following: lateral cracks, forward chevron tensile cracks, arc tensile cracks, hertzian tensile cracks, conformal cracks or buckling cracks. There was also no buckling spallation, wedging spallation, recovery spallation, gross spallation or chipping. The corresponding acoustic emission did not indicate any delamination.

The MoSi₂ nanostructure coated stainless steel coupon (Nano-5T-RO) was subjected to standard ASTM scratch tests. Load weights tested ranged from 0.3 to 100 mN. These tests indicate an adherent coating. The main conclusions from the scratch tests are that the (500 to 1000 nm) thick coatings (i) did not delaminate under even the highest load (100 mN), (ii) the coatings did not crack, (iii) the coatings did not chip off, and (iv) behaved in a somewhat ductile-manner similar to the substrate stainless steel.

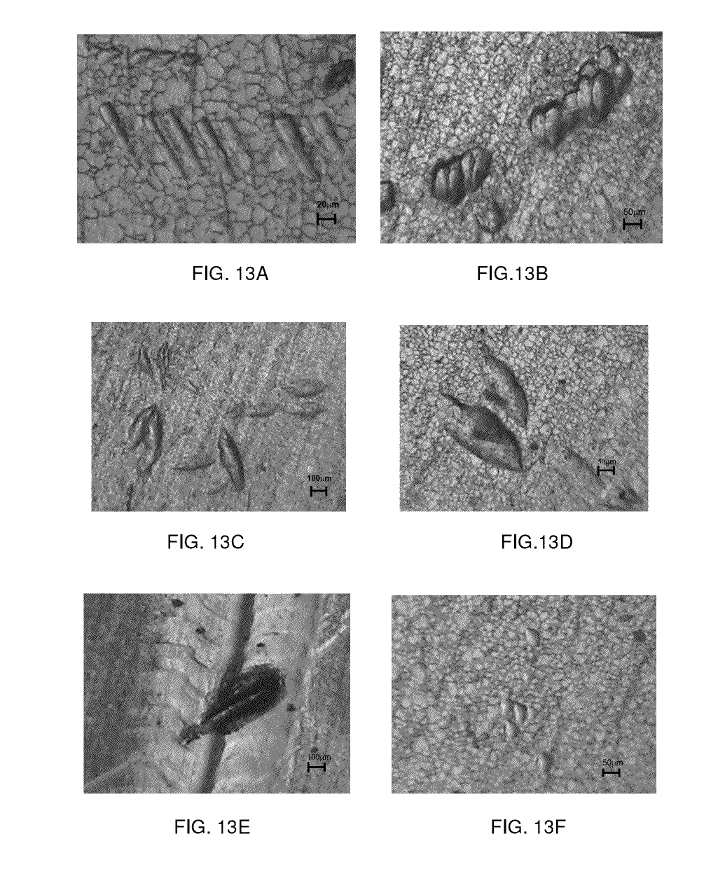

Biofilms have significant complexity as discussed above. In natural environments many microbes form biofilms. Generally, the microbes in a biofilm are held together with polysaccharides. Rod and fiber-like morphologies are commonly noted in biofilms. The various surfaces which had been exposed to the nutrient during the swabbing process were exposed for over 2100 hours to room air. During this period the temperature in the room varied between 25-30 C and the RH varied between 50-80%. FIGS. 13A through 13F show rod like shapes appearing and growing on the Original -5T(ss) for 642 and 834 hrs. None of the Nano-5T or Nano-5T-RO surface shows these features. Thus, we conclude that the nanostructured surfaces not only prevented or delayed bacterial colonies from forming, but appear to have eliminated biofilm formation. This connection between nanostructures and biofilms is made for the first time. Corrosion was noted under the biofilm.

Several main conclusions are evident from the above research. Nanoparticles that form adherent nanostructured surfaces are antibiofilm in a permanent sense. Nanostructures, especially nanoporous structures, have greater efficacy compared to the same surfaces without curvature. MoSi₂ is antibiofilm as is silver even for very high initial bacterial concentrations (tested up to about 10⁶ cfu's/ml for Gram+ and Gram−ve). Coatings display antibacterial properties even after mild abrasion. The efficacy of an antimicrobial agent may change with the particular microbe. For tests with top-soil (i.e., containing multiple containing diverse species) bacteriostatic action was also noted for a 2 hour contact time. Increasing the contact time increases the lag phase of the bacterial colony growth curve. Specifically, it has been found that Methicillin-resistant Staphylococcus aureus (MRSA) is particularly removed b means of oxycarbides, nanocarbides and nano-oxides which can be part of the composition of the nanoporous nanostructures.

Drying and spread rate tests are proposed as a method for quick assessment of the efficacy and retention of the nano-structured surfaces. A BQUICKT™ test and test kit is therefore proposed. Such tests include the applying of water droplets followed by drying and spread rate measurements and evaluation. Kits could include the needed equipment such as droppers, containers measurement devices and any required instructions to allow a quick and portable method of testing. Long time exposures indicated that Biofilm formation is delayed or eliminated by the nanostructured surfaces with the use of such tests.

Also, the effectiveness of an applied nanosurface in preventing biofilms and eliminating microbes and bacteria can be tested through the use of tapes or patches, nanostructured and nanocoated with the MoSi₂ or other materials, and placed in areas where the need for protection is anticipated. These tapes or patches would be non-permanent and easily removable to allow examination and comparison with uncoated test strips applied in the same area. A comparison would allow the efficacy of the nanocoating to be determined. It is indicated as well that the properties of the applied nanosurface is also effective when painted or otherwise coated with organic materials such as paints, etc.

Again, proposed is also a very quick method for determining surface efficacy and a very quick method to sample Petri dishes (early detection). The drying and spreading method is discussed above. For Petri dish methods light or other scattering methods are proposed. Also, the use of chemical sniffers that test for combustible and non combustible gas is proposed as well as pH measurements all in the nutrient solution where growth is sampled. For example, detectors could be employed to detect gases produced by the growth of bacteria, such as hydrogen. Such methods can be the basis of test kits. Also UV calorimetry and all methods that lead to detection of specific expressed molecules are included.

Also, the detection of odd cells like cancer cells can benefit from this method and the coating could be useful for preventing the growth and spread of cancerous cells by using nanostructured coatings on implants, stents (bile duct, heart, artery and general internal body applications), pins and connectors. Bile stents and others stents, to be nanocoated, may be comprised of compounds comprising alloys including stainless steel, Ni—Mo, Ni—Ti—Fe, Ni—Ti, Ni—Al—Ti, Ni—Mo—Fe, Ni—Al—Ti—Fe, Ni—Fe—Al and Mo along with oxides and carbides. Recent studies have shown that cancer inhibiting drugs can be tested using chemiluminescence to detect nanoparticles coated in part with titanium ions that attach to phosphorylated proteins. These coated nanoparticles can detect any kind of phosphorylation in a protein. These proteins indicate the presence kinase (enzyme that causes cancer cell formation when overactive) activity. If a cancer drug is effective, the color of a test solution will display a light color, indicating less kinase activity. New nanostructures could thus be tested and old cancer inhibitors including radioisotopes and antibodies could be replaced. It is anticipated that in a like manner the nanostructures discussed in the present application could be used to target and detect cancer cells and to also indicate their size, as well as, bacterial colony size and concentration through light color, UV or IR wavelength and intensity. Also the use of radiation in conjunction with the nanostructure or nanostructure coating may be employed for target specific cells once adhered to, or in proximity to, such objects whether inside or outside the body. Uses for in vivo and in vitro testing are anticipated as well. The technology presented by the present application, where applied, can prevent the spread and colony formation of new strains and species of bacteria which arise after natural or man-made disasters such as oceanic oil leaks, earthquake or nuclear disasters. Such oil leaks have led to the introduction modified bacteria to eat the oil and resultant biofilm formation. Any health risks created by such biofilms can be eliminated by the application of the proposed technology of the present application.

TABLE 1
Antiviral studies with Bacteriophages.

| | Coupon with | | |
|---|---|---|---|
| | nanostructured MoSi₂ | | |
| Microorganism | on Stainless Steel | Contact Time | PFU/Coupon |
| Phi 6 | Nano-5T(MoSi₂) | Time Zero | 2.90E+05 |
| Bacteriophage | Nano-5T(MoSi₂) | 24 hrs. | <5 Non-detect |
| (HB10YB) | | | |
| (From external | | | |
| FDA approved | | | |
| Laboratory) | | | |

Note that these are 24 hour standard test studies.
PFU: Plaque-forming unit

TABLE 2
Evolution of Bacillus Cereus colonies on different surfaces MoSi₂ surfaces
compared to the control Original-% T 316L stainless steel surface. 2 hour
contact time at 25° C., 51% RH and 24 hours of incubation at 35° C.

| Incubation | | | | | | |
|---|---|---|---|---|---|---|
| time for | | | | | | |
| Bacillus | | Nano-5T-RO(MoSi₂) | Flat MoSi₂ | | Original-5T (i.e. | |
| cereus, hours | Nano-5T(MoSi₂) | [S186-A] | (Original-5T(MoSi₂) | | uncoated 316L) | |
| | | | | | Size: | Quantity: |
| 14 | No colonies | No colonies | No colonies | | ~0.2 | ~200 |
| | | | | | ~0.1−0.15 | >10,000 |
| | | | Size: | Quantity: | Size: | Quantity: |
| 18 | No colonies | No colonies | ~0.1 | 1 | ~0.1−0.15 | >10,000 |
| | | | Size: | Quantity: | Size: | Quantity: |
| 24 | No colonies | No colonies | ~0.2 | 1 | ~0.3 | >10,000 |
| | | | ~0.1−0.2 | 22 | | |

TABLE 3
Average drying rate of the three types of surfaces

| | Drying rate, mg/minute. | |
|---|---|---|
| Sample | (Room temperature | Speed of spreading/ |
| identification | 28° C., 80% RH) | Wetting angle |
| Nano-5T | 1.2 | Instant wetting, Wetting |
| (MoSi₂) | | angle is low <10 degrees. |
| Nano-5T-RO | 0.7 | Moderate. Wetting |
| (MoSi₂) | | angle ~40 degrees. |
| Original-5T | 0.4 | Very slow. Wetting |
| Uncoated | | angle ~80 degrees. |
| (Bare stainless | | Hemispherical cap. |
| steel) | | |

The above descriptions provide examples of specifics of possible embodiments of the application and should not be used to limit the scope of all possible embodiments. Thus the scope of the embodiments should not be limited by the examples and descriptions given, but should be determined from the claims and their legal equivalents.

We claim:

1. A nanoporous structure comprising:
a framework of non-porous material comprised of nanoparticles, and
at least one nanopore supported in the framework, said nanopore measuring less than 1000 nanometers in one direction wherein the structure exhibits antibiofilm properties.

2. The nanoporous structure of claim 1 further comprising:
a substrate, and
a coating applied to a surface of the substrate, wherein the coating comprises the framework of non-porous material comprised of nanoparticles and a plurality of nanopores supported in the framework, wherein at least one portion of the substrate is covered by the coating.

3. The nanoporous structure of claim 2 wherein said coating is comprised of multiple nanoporous layers, said multiple nanoporous layers forming a chemical gradient.

4. The nanoporous structure of claim 2 wherein said coating is comprised of multiple nanoporous layers, said multiple nanoporous layers forming a porous gradient.

5. The nanoporous structure of claim 2 wherein said plurality of nanopores has a sub-micron average size.

6. The nanoporous structure of claim 2 wherein the non-porous material comprise at least one of: silver, tungsten, iron, carbon, aluminum, copper, nickel, iron, SiC, SiOₓ, MoSi₂, an oxide of at least one of nickel, iron, tungsten, or chromium, Cu, Ag, Au, Pt, Pd, Ir, a rare earth metal, a semiconductor, B, Si, Ge, As, La, Sb, Te, Po, an iron oxide, a tungsten oxide, a chromium oxide, VₓO_{y}, FeₓO_{y}, FeOₓ, FeₓO_{y}, aluminum oxide, NiO, zinc oxide, tin oxide, hafnium carbide, tungsten carbide, MnOₓ, SiOₓ, MoOₓ, HfOₓ, WO₃, TiBₓ, CrOₓ, NbₓO_{y}, AlₓZr, BₓC, SiOₓ, ZrSiOₓ, BₓO_{y}, CdS, MnS, MoSₓ, NaNₓ, NaCN, SiₓN_{y}, PbO, PbOₓ, WOₓ, WOₓ, BaOₓ, SiOₓ, NiFeₓO_{y}, FeMoSₓ, FeₓNO_{y}, AlₓO_{y} and a further defect compound, where x and y represent non-integer values, or at least one of an oxide, a carbide, a nitride, an aluminide, a boride, a silicide, or a halide of at least one of Cu, Ag, Au, Fe, Si, W, Mo, Ti, Hf, Pt, Pd, or Ir and all combinations, alloys and mixtures thereof.

7. The nanoporous structure of claim 2 wherein said non-porous material is comprised of both sharp and smooth nanoparticles.

8. The nanoporous structure of claim 7 wherein the nanoparticles have a size of 1-100 nanometers.

9. The nanoporous structure of claim 7 wherein the nanoparticles have shapes selected from the group consisting of fcc, bcc, hcp, bct, tetragonal, monoclinic, and amorphous or quasi-crystalline morphologies.

10. (canceled)

11. (canceled)

12. (canceled)

13. (canceled)

14. The nanoporous structure of claim 2 wherein said substrate is comprised of a material selected from the group consisting of metal, ceramic, non-metal, organic, wood, glue, paint and cement.

15. The nanoporous structure of claim 2 wherein said coating is comprised of inorganic material.

16. The nanoporous structure of claim 2 wherein said coating has a thickness less than 1000 nanometers.

17. The nanoporous structure of claim 2 further comprising:
a means for testing to ascertain a presence of microbes and biofilm and efficacy of antibiofilm coating in eliminating microbes and biofilms on surfaces, the means for testing comprising:
a means to expose the coating to an environment where microbes may be present;
a means to detect the presence of microbes or biofilm employing a device selected from the group consisting of drying rate kit, spreading rate kit, chemical sniffer, UV calorimeter, pH test kit and test strips coated with the antibiofilm coating; and
a means to measure the relative microbial and biofilm forming efficacy.

18. The nanoporous structure of claim 17 wherein said test strips are removable non-permanent devices selected from the group consisting of tapes, patches and stickers.

19. The nanoporous structure of claim 17 wherein said test strips are self-adhesive.

20. An apparatus for providing a durable nanoporous nanostructure comprising:
at least one electrode; and
an electrode arrangement which is configured to produce an electrical arc at a distal end of the electrode without the distal end of the electrode being in proximity to an electrically grounded object, and which is further configured to provide the nanoporous nanostructure wherein the structure exhibits antibiofilm properties.

21. The apparatus of claim 20 wherein the nanoporous structure further comprises:
a substrate, and
a coating applied to a surface of the substrate, wherein the coating comprises a plurality of nanopores, and non-porous material and wherein at least one portion of the substrate is covered by the coating.

22. The apparatus of claim 21 wherein the non-porous material is comprised of at least one of: silver, tungsten, iron, carbon, aluminum, copper, nickel, iron, SiC, SiOₓ, MoSi₂, an oxide of at least one of nickel, iron, tungsten, or chromium, Cu, Ag, Au, Pt, Pd, Ir, a rare earth metal, a semiconductor, B, Si, Ge, As, La, Sb, Te, Po, an iron oxide, a tungsten oxide, a chromium oxide, VₓO_{y}, FeₓO_{y}, FeOₓ, FeₓO_{y}, aluminum oxide, NiO, zinc oxide, tin oxide, hafnium carbide, tungsten carbide, MnOₓ, SiOₓ, MoOₓ, HfOₓ, WO₃, TiBₓ, CrOₓ, NbₓO_{y}, AlₓZr, BₓC, SiOₓ, ZrSiOₓ, BₓO_{y}, CdS, MnS, MoSₓ, NaNₓ, NaCN, SiₓN_{y}, PbO, PbOₓ, WOₓ, WOₓ, BaOₓ, SiOₓ, NiFe_{y}O_{z}, MoSₓ, FeMoSₓ, FeₓNO_{y}, AlₓO_{y} and a further defect compound, where x and y represent non-integer values, or at least one of an oxide, a carbide, a nitride, an aluminide, a boride, a silicide, or a halide of at least one of Cu, Ag, Au, Fe, Si, W, Mo, Ti, Hf, Pt, Pd, or Ir and all combinations, alloys and mixtures thereof.

23. (canceled)

24. The apparatus of claim 21 wherein the non-porous material is comprised of a plurality of nanoparticles having a sub-micron average size.

25. The apparatus of claim 21 wherein said substrate is comprised of a material selected from the group consisting of stainless steel, aluminum, copper, nickel, plastic and PVC.

26. A method for providing a durable nanoporous nanostructure on a substrate, the method comprising:
producing an arc at a distal end of an electrode using an electrode arrangement which is configured to produce an electrical arc at a distal end of the electrode without the distal end of the electrode being in proximity to an electrically grounded object, wherein the arc is configured to discharge particular particles from the electrode; and
providing the substrate in a proximity to the arc, wherein the particles are provided on at least one portion of the substrate and at least partially adhere to at least one of the substrate or further particles, wherein an average size of the particles is sub-micron, and wherein the coating exhibits antibiofilm properties.
